(19) United States
(12) Patent Application Publication
(10) Pub. No.: US 2008/0075865 A1
(43) Pub. Date: Mar. 27, 2008

(54) Ceramic bisque product with underglaze outlines

(76) Inventor: Judy McConnell Randle, Canyon Lake, CA (US)

Correspondence Address: CHRISTIE, PARKER & HALE, LLP, PO BOX 7068, PASADENA, CA, 91109-7068, US

(21) Appl. No.: 11/903,262

(22) Filed: Sep. 21, 2007

Related U.S. Application Data
(60) Provisional application No. 60/846,480, filed on Sep. 22, 2006.

(51) Int. Cl. B05D 3/02

(52) U.S. Cl. 427/374.7

(57) ABSTRACT

A molded clay object with decorative indicia and a method for preparing a molded clay object for receiving finishing decorations, where the steps include applying ceramic paint to the molded clay object with an applicator to trace on the molded clay object a complete outline of decorative indicia, firing the molded clay object in a kiln to fix the outline in a permanent state whereby the object is prepared to receive coloration and other decorative material applied by a user prior to being glazed and fired a second time to produce a finished object; and cooling the molded clay object in the kiln to room temperature.

### CROSS-REFERENCE TO RELATED APPLICATION(S)

This application claims the benefit of U.S. Provisional Application Ser. No. 60/846,480, filed Sep. 22, 2006, the disclosure of which is incorporated by reference.

### FIELD OF THE INVENTION

The present invention relates generally to paint-it-yourself ceramics and more specifically to a ceramic bisque product with underglaze outlines for the novice consumer who desires on their first attempt to decorate ceramics with results that prior to this invention were only available to well experienced, well trained and talented artists.

### BACKGROUND OF THE INVENTION

It can be appreciated that paint-it-yourself ceramics have been in use for years. Typically, paint-it-yourself ceramics are comprised of plain white molded clay objects that have been kiln fired at high temperatures to create a hardened ceramic piece commonly known as “bisque.” The plain white bisque is then decorated using a wide range of ceramic paints, glazes or other products.

The main problem with conventional paint-it-yourself ceramics is the lack of successful results by inexperienced, untrained or untalented “novice” consumers. Decorating ceramics with professional looking results requires painting experience, training, or natural talent, as well as an understanding of the medium. Conventional paint-it-yourself ceramics offer the consumer only a blank canvas (bisque) with which to begin. Without experience, training or natural artistic talent, existing products leave consumers with the potential of being dissatisfied. Another problem with conventional paint-it-yourself ceramics is that consumers see painted ceramics in everyday life. To some, it may look so simple and they often think that they can just sit down with a undecorated blank piece of bisque and experience similar results on their first try. These consumers are frequently disappointed that their results fall short of their expectations. These same fears keep others from ever attempting paint-it-yourself ceramics. Another problem with conventional paint-it-yourself ceramics are that the ceramics we see in everyday life are not realistic examples of results that a novice can expect. Without an understanding of the medium, consumers cannot comprehend what is possible with certain ceramic products and how they should be applied. Consumers frequently attempt projects or designs that can not be produced without numerous products and processes that are not readily understood by mere observation.

While these devices may be suitable for the particular purpose for which they are designed, they are not as suitable for the novice consumer who desires on their first attempt to decorate ceramics with results that prior to this invention were only available to well experienced, well trained, and talented artists.

In these respects, the ceramic bisque product with underglaze outlines according to the present invention substantially departs from the conventional concepts and designs of the prior art, and in so doing, provides an apparatus primarily developed for the purpose of the novice consumer who desires on their first attempt to decorate ceramics with results that prior to this invention were only available to well experienced, well trained and talented artists.

### SUMMARY OF THE INVENTION

In view of the foregoing disadvantages inherent in the known types of paint-it-yourself ceramics now present in the prior art, the present invention provides a new ceramic bisque product with underglaze outlines, wherein the same can be utilized for the novice consumer who desires on their first attempt to decorate ceramics with results that prior to this invention were only available to well experienced, well trained and talented artists.

The general purpose of the present invention, which will be described subsequently in greater detail, is to provide a new ceramic bisque product with underglaze outlines that has many of the advantages of the paint-it-yourself ceramics mentioned heretofore and many novel features that result in a new ceramic bisque product with underglaze outlines which is not anticipated, rendered obvious, suggested, or even implied by any of the prior art paint-it-yourself ceramics, either alone or in any combination thereof.

To attain this, the present invention generally comprises pieces of ceramic bisque that have been enhanced with underglaze outlines designed by professional artists with years of experience and training who understand the medium. The artists' designs are then painted onto bisque items in the form of basic outlines using underglaze ceramic paints. The bisque pieces are again fired in a kiln causing the painted outlines to become one with the original bisque piece. To produce a professional looking ceramic art piece, the consumer need only paint between the lines. Unlike “paint-by-numbers” techniques used previously on canvas painting projects, the underglaze outlines are not covered up and become an integral part of the finished piece. The initial component is a molded or pressed clay object that has been hardened by kiln firing into what is known as “bisque.” Bisque pieces are enhanced in this invention by the addition of professionally designed underglaze outlines. The outline enhanced bisque piece is then subjected to a second kiln firing that causes the outline to become one with the original piece. The end result is an underglaze outline that is not covered up but rather is an integral part of the finished piece.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a ceramic bisque product with underglaze outlines that will overcome the shortcomings of the prior art devices.

An object of the present invention is to provide a ceramic bisque product with underglaze outlines for the novice consumer who desires on their first attempt to decorate ceramics with results that prior to this invention were only available to well experienced, well trained and talented artists.

Another object is to provide a ceramic bisque product with underglaze outlines that is by design so simple that the novice consumer can successfully produce a professional looking piece of ceramic art where the underglaze outlines of this invention become an integral part of the finished ceramic art piece.

Another object is to provide a ceramic bisque product with underglaze outlines that requires no understanding of the medium, no prior experience, and no artistic talent, on the part of the consumer.

Another object is to provide a ceramic bisque product with underglaze outlines that requires only a minimal time commitment to the project by the consumer. Many project design have an estimated completion time of an hour or less.

Another object is to provide a ceramic bisque product with underglaze outlines that requires no prior training on the part of the consumer.

Another object is to provide a ceramic bisque product with underglaze outlines that eliminates the novice consumers' risk of disappointment and offers immediate gratification.

Another object is to provide a ceramic bisque product with underglaze outlines that entertains the consumer while leaving them with a successful art piece of which they can be proud.

Another object is to provide a ceramic bisque product with underglaze outlines that exposes consumers to an activity that they might otherwise not have attempted given the hours of training and education previously necessary to obtain the same results prior to this invention.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

One embodiment of the present invention is a method for preparing a molded clay object for receiving finishing decorations, the method including applying ceramic paint to the molded clay object with an applicator to trace on the molded clay object a complete outline of decorative indicia; firing the molded clay object in a kiln to fix the outline in a permanent state whereby the molded clay object is prepared to receive coloration and other decorative material applied by a user prior to being glazed and fired a second time to produce a finished object; and cooling the molded clay object in the kiln to room temperature.

Another aspect of one embodiment is regions within the outline identify areas for ceramic paint application and includes the step of applying ceramic paint to produce the desired finished coloration and decoration.

Another aspect of one embodiment is coating the molded clay object with an acrylic material suitable for decoration with indelible ink.

Another aspect of one embodiment is applying indelible inks of selected colors to produce the finished object.

Another aspect of one embodiment is the ceramic paint is a single color.

Another aspect of one embodiment is the ceramic paint includes a medium including crushed glass.

One embodiment of the present invention is a molded clay object for receiving finishing decorations, the method including applying ceramic paint to a first screen with perforations having an outline of a first decorative indicia; using an applicator to press the ceramic paint through the perforations onto the molded clay object; firing the molded clay object in a kiln to fix the first decorative indicia in a permanent state; and cooling the molded clay object in the kiln to room temperature.

Another aspect of one embodiment is regions within the outline identify areas for ceramic paint application and includes the step of applying ceramic paint to produce the desired finished coloration and decoration.

Another aspect of one embodiment is coating the molded clay object with an acrylic material suitable for decoration with indelible ink.

Another aspect of one embodiment is applying indelible inks of selected colors to produce the finished object.

Another aspect of one embodiment is the ceramic paint is a single color.

Another aspect of one embodiment is the ceramic paint includes a medium including crushed glass.

One embodiment of the present invention is a method for preparing a molded clay object for receiving finishing decorations, the method including applying ceramic paint to a first screen with perforations having an outline of a first decorative indicia; using an applicator to press the ceramic paint through the perforations onto a first side of a first sheet of transfer paper; applying the first side of the first sheet of transfer paper to the molded clay object to transfer the first decorative indicia to the molded clay object; removing the first sheet of transfer paper from the molded clay object; firing the molded clay object in a kiln to fix the first decorative indicia in a permanent state; and cooling the molded clay object in the kiln to room temperature.

Another aspect of one embodiment is applying ceramic paint to a second screen with perforations having an outline of a second decorative indicia; using an applicator to press the ceramic paint through the perforations onto a first side of a second sheet of transfer paper; applying the first side of the second sheet of transfer paper to the molded clay object to transfer the second decorative indicia to the molded clay object; removing the second sheet of transfer paper from the molded clay object; wherein the second sheet of transfer paper is removed prior to firing the molded clay object.

Another aspect of one embodiment is the ceramic paint is a slow-drying formulation.

Another aspect of one embodiment is regions within the outline identify areas for ceramic paint application and includes the step of applying ceramic paint to produce the desired finished coloration and decoration.

Another aspect of one embodiment is coating the molded clay object with an acrylic material suitable for decoration with indelible ink.

Another aspect of one embodiment is applying indelible inks of selected colors to produce the finished object.

Another aspect of one embodiment is the ceramic paint is a single color.

Another aspect of one embodiment is the ceramic paint includes a medium including crushed glass.

One embodiment of the present invention is a method for decorating a molded clay object, the method including applying ceramic paint to the molded clay object within regions indicated by decorative indicia, wherein the decorative indicia has been fixed in a permanent state to the molded clay object by a first firing in a kiln; coating the molded clay object in a glaze; firing the molded clay object in the kiln to fix the ceramic paint in a permanent state and create a wear-resistant coating; and cooling the molded clay object in the kiln to room temperature.

One embodiment of the present invention is a method for preparing and decorating a molded clay object, the method including: applying ceramic paint to the molded clay object with an applicator to trace on the molded clay object a complete outline of decorative indicia; firing the molded clay object in a kiln a first time to fix the outline in a permanent state; cooling the molded clay object in the kiln to room temperature; applying ceramic paint to the molded clay object within regions indicated by decorative indicia; coating the molded clay object in a glaze; firing the molded clay object in the kiln a second time to fix the ceramic paint in a permanent state and create a wear-resistant coating; and cooling the molded clay object in the kiln to room temperature.

Another aspect of one embodiment is the ceramic paint is a single color.

Another aspect of one embodiment is the ceramic paint comprises a medium comprising crushed glass.

Another aspect of one embodiment is the ceramic paint is a slow-drying formulation.

One embodiment of the present invention is a method for preparing and decorating a molded clay object, the method including: applying ceramic paint to the molded clay object with an applicator to trace on the molded clay object a complete outline of decorative indicia; firing the molded clay object in a kiln a first time to fix the outline in a permanent state; cooling the molded clay object in the kiln to room temperature; coating the molded clay object with an acrylic material suitable for decoration with indelible ink; applying indelible ink to the molded clay object within regions indicated by decorative indicia.

Another aspect of one embodiment is the ceramic paint is a single color.

Another aspect of one embodiment is the ceramic paint includes a medium including crushed glass.

Another aspect of one embodiment is the ceramic paint is a slow-drying formulation.

One embodiment of the present invention is a molded clay object for receiving finishing decorations, wherein: ceramic paint is applied to the molded clay object with an applicator to trace on the molded clay object a complete outline of decorative indicia; the molded clay object is fired in a kiln to fix the outline in a permanent state whereby the molded clay object is prepared to receive coloration and other decorative material applied by a user prior to being glazed and fired a second time to produce a finished object; and the molded clay object is cooled in the kiln to room temperature.

Another aspect of one embodiment is regions within the outline identify areas for ceramic paint application and includes the step of applying ceramic paint to produce the desired finished coloration and decoration.

Another aspect of one embodiment is the molded clay object is coated with an acrylic material suitable for decoration with indelible ink.

Another aspect of one embodiment is indelible inks of selected colors are applied to the molded clay object to produce the finished object.

Another aspect of one embodiment is the ceramic paint is a single color.

Another aspect of one embodiment is the ceramic paint includes a medium including crushed glass.

One embodiment of the present invention is a molded clay object for receiving finishing decoration including: a blank object having been subjected to a first firing in a kiln to create a bisque; a pattern of indices tracing a decorative pattern on the object, the pattern of indices having been created by applying ceramic paint in the decorative pattern and thereafter being subjected to a second firing to permanently fix the pattern of indices on the object; wherein the object is ready to receive the finishing decoration to be applied by a user of the object.

### BRIEF DESCRIPTION OF THE DRAWINGS

The attached drawings illustrate methods of applying decorative indicia and applying ceramic paint within the regions indicated by the decorative indicia of this invention, wherein:

FIG. 1A is a perspective view of a curved molded clay object.

FIG. 1B is a perspective view of a flat molded clay object.

FIG. 2A is a perspective view of a curved molded clay object after decorative indicia has been applied.

FIG. 2B is a perspective view of a flat molded clay object after decorative indicia has been applied.

FIG. 3A is a perspective view of a curved molded clay object after decorative indicia has been applied and ceramic paint has been applied within the regions indicated by the decorative indicia.

FIG. 3B is a perspective view of a flat molded clay object after decorative indicia has been applied and ceramic paint has been applied within the regions indicated by the decorative indicia.

FIG. 4A is a view of a sheet of transfer paper.

FIG. 4B is a view of ceramic paint being applied to a sheet of transfer paper through a screen with perforation in an outline of decorative indicia by an applicator.

FIG. 4C is a view of a sheet of transfer paper after an outline of decorative indicia has been applied.

FIG. 4D is a view of a sheet of transfer paper being applied to a curved molded clay object.

### DETAILED DESCRIPTION OF THE INVENTION

Turning now descriptively to the drawings, in which similar reference characters denote similar elements throughout the several views, the attached figures illustrate a ceramic bisque product with underglaze outlines, which comprises pieces of ceramic bisque that have been enhanced with underglaze outlines designed by professional artists with years of experience and training who understand the medium. The artists' designs are then painted onto bisque items in the form of basic outlines using underglaze ceramic paints. The bisque pieces are again fired in a kiln causing the painted outlines to become one with the original bisque piece. To produce a professional looking ceramic art piece, the consumer need only paint between the lines. Unlike “paint-by-numbers” techniques used previously on canvas painting projects, the underglaze outlines are not covered up and become an integral part of the finished piece. The initial component is a molded or pressed clay object that has been hardened by kiln firing into what is known as “bisque.” Bisque pieces are enhanced in this invention by the addition of professionally designed underglaze outlines. The outline enhanced bisque piece is then subjected to a second kiln firing that causes the outline to become one with the original piece. The end result is an underglaze outline that is not covered up but rather is an integral part of the finished piece.

The initial component is a molded or pressed clay object that has been hardened by kiln firing into what is known as “bisque.” Bisque is a molded or pressed piece of clay having been hardened by kiln firing. Bisque is commonly available in a variety of shapes and sizes including functional items such as plates, mugs, clock and pictures frames to non-functional decorative items.

Bisque pieces are enhanced in this invention by the addition of professionally designed underglaze outlines. Underglaze outlines are painted onto bisque items. Underglaze outlines are designed by talented artists with years of training and experience that are an integral part of the finished project.

The outline enhanced bisque piece is then subjected a second kiln firing that causes the outline to become one with the original piece. Underglaze outlines become a permanent part of the original bisque piece which results in new product substantially different from the original art. The designs will not wash off and will show through later design efforts by the consumer.

The end result is an underglaze outline that is not covered up but rather an integral part of the finished piece. The end result is a professional looking decorated piece of art. The underglaze outlines become a bold and integral part of the finished piece and the primary focus of an observer causing added decorations by the consumer to become secondary.

Professional designs are painted in outline form onto ceramic bisque, exposed to a second kiln firing so as to cause the outlines to become one with the original bisque piece. Outlines may vary in thickness and color. Underglaze products may be applied by brush, spray or other methods.

Bisque, molded or pressed pieces of clay, are hardened by kiln firing. Ceramic underglazes are added to the piece in the form of outlines. Bisque pieces are subject to a second kiln firing causing them to become one with the original object. The outlines are decorated and not covered and become an integral part of the finished project.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further; since numerous modifications and changes will readily occur to those skilled in the art, it is not desired to limit the invention to the exact construction and operation shown and described, and accordingly, all suitable modifications and equivalents may be resorted to, falling within the scope of the invention.

A method for preparing a molded clay object for receiving decorative indicia is provided.

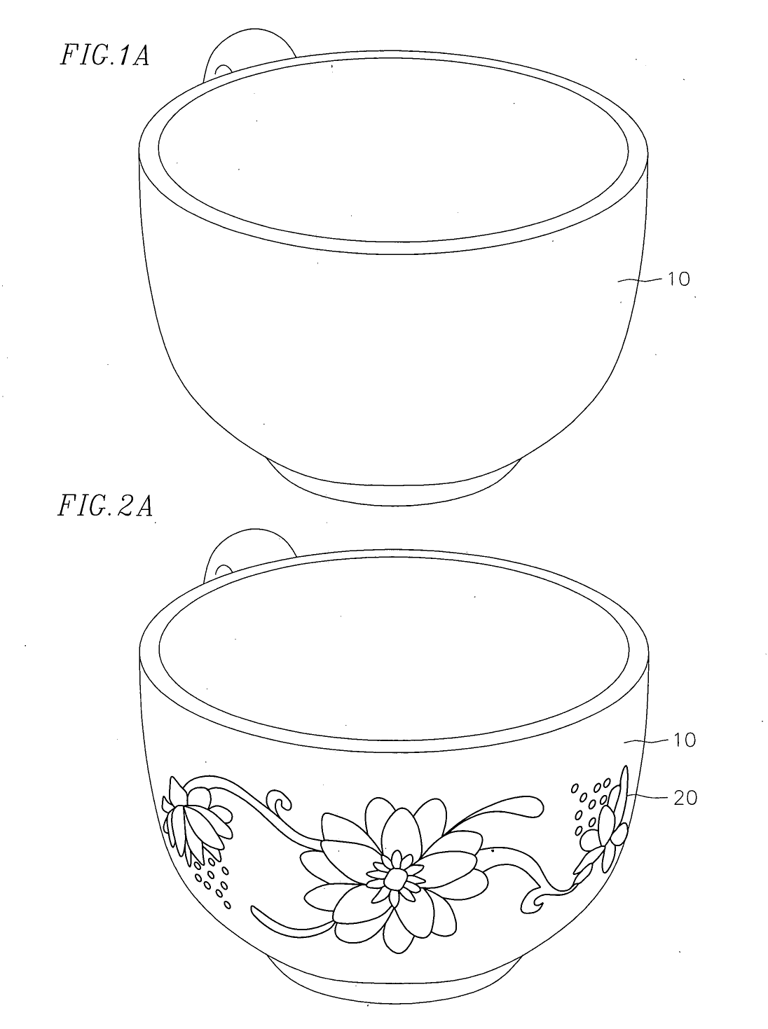

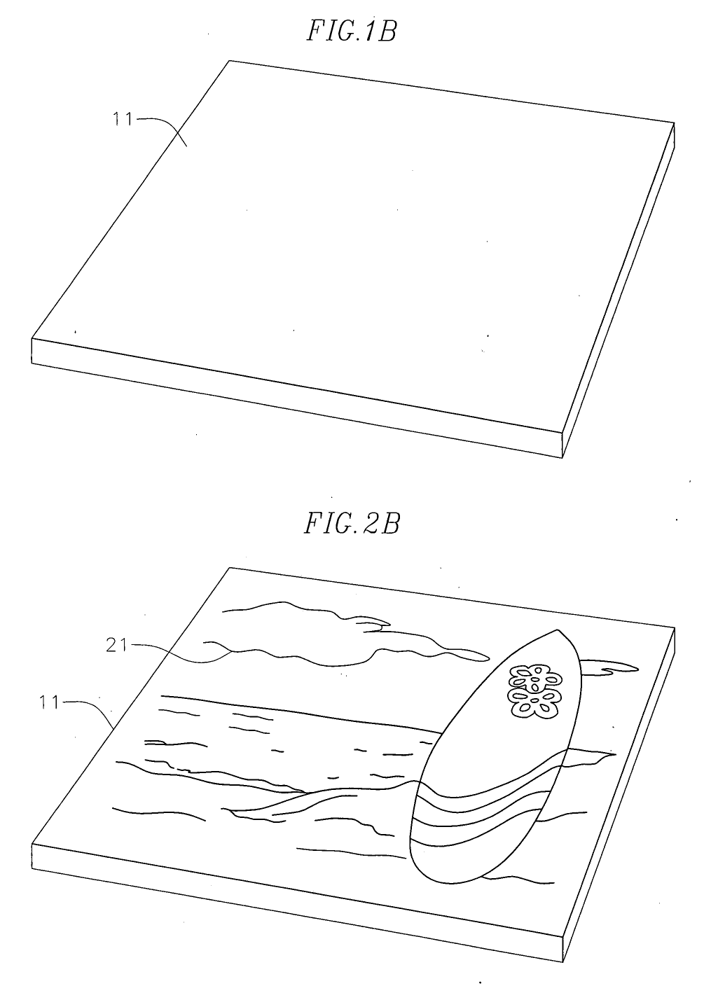

In one embodiment, as shown in FIGS. 1A and 1B, a blank molded clay object 10, 11 is selected for decoration. The molded clay object 10, 11 has been hardened by kiln firing into what is known as bisque. Bisque is commonly available in a variety of shapes and sizes including plates, mugs, clock, pictures, figurines and other decorative items.

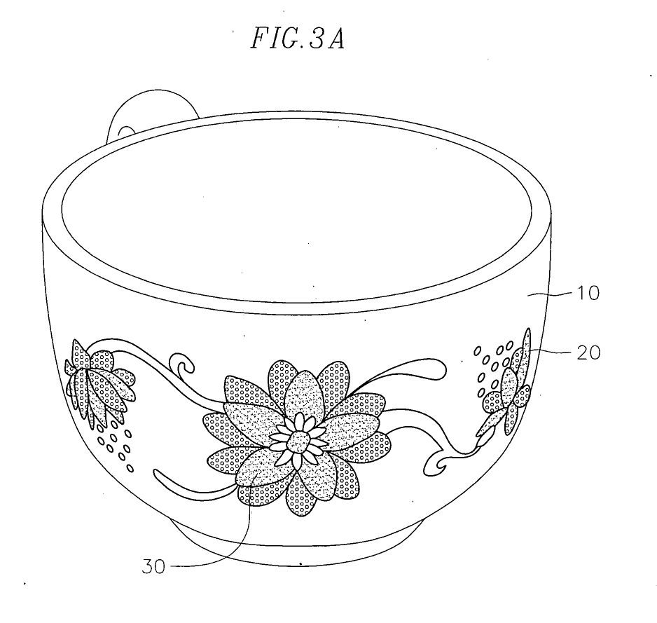

An artist designs decorative indicia to be applied to the molded clay object. Ceramic paint is applied to the molded clay object with an applicator to trace a complete outline of the decorative indicia 20 and 21, as shown in FIGS. 2A and 2B, respectively. In one embodiment, the ceramic paint may be composed of a medium including crushed glass, in addition to other products. The decorative indicia 20 and 21 are only representative of decorative indicia that may be used. Decorative indicia of any shape may be used in the present invention. The ceramic paint may be applied by brush, spray, screenprinting, or other methods.

After the ceramic paint is applied, the molded clay object 10, 11 is fired and cooled to room temperature in a kiln, permanently fixing the decorative indicia 20, 21 in a traced outline on the object. The decorative indicia 20, 21 will not wash off and will show through later decoration.

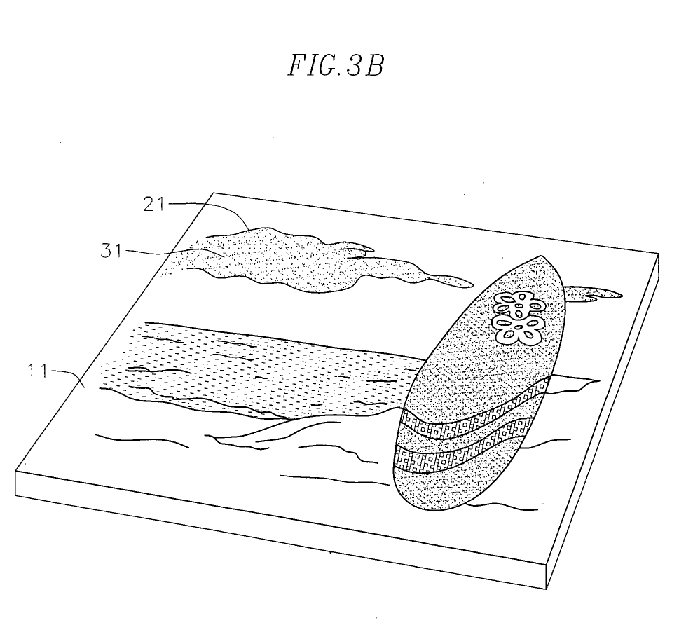

Once the molded clay object 10, 11 is removed from the kiln, it may be decorated by a consumer. The consumer applies ceramic paint to the curved molded clay object in the spaces within regions 30, 31 indicated by the decorative indicia 20, 21, as shown in FIGS. 3A and 3B. The molded clay object 10, 11 is thereafter coated with a glaze. The glazed molded clay object 10, 11 is then fired a second time and cooled to room temperature in a kiln to fix the ceramic paint in a permanent state and create a wear-resistant coating. The decorative indicia outline 20, 21 remain visible in the finished piece.

In another embodiment, the decorative indicia is applied to molded clay object by a screen printing process. The screen printing process may be used to apply the decorative indicia 21 to a flat molded clay object 11. In the screen printing process, ceramic paint is applied to a screen with perforations having an outline of the decorative indicia 21. The flat molded clay object 11 is placed under the screen. An applicator is used to press the ceramic paint through the perforations in the screen to deposit the ceramic paint onto the flat molded clay object 11.

The flat molded clay object 11 is then fired and allowed to cool in a kiln to permanently fix the decorative indicia.

Once the flat molded clay object 11 is removed from the kiln, it may be decorated by a consumer. The consumer applies ceramic paint to the flat molded clay object 11 within regions 31 indicated by the decorative indicia 21, as shown in FIG. 3B. The colored and decorated flat molded clay object 11 is thereafter coated with a glaze. The flat molded clay object 11 is fired and cooled to room temperature in a kiln to fix the ceramic paint in a permanent state and create a wear-resistant coating. The outlines remain visible in the finished piece.

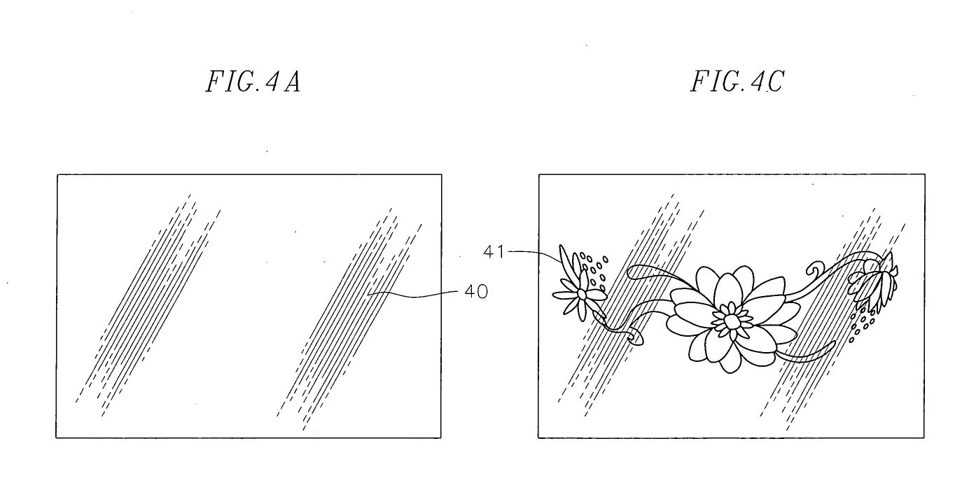

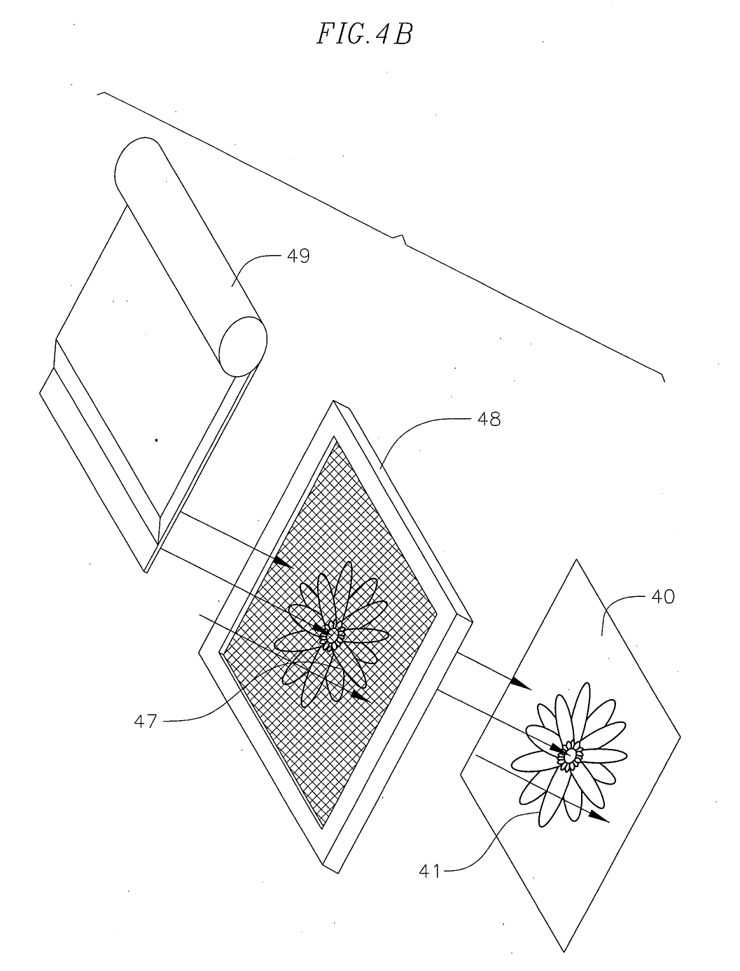

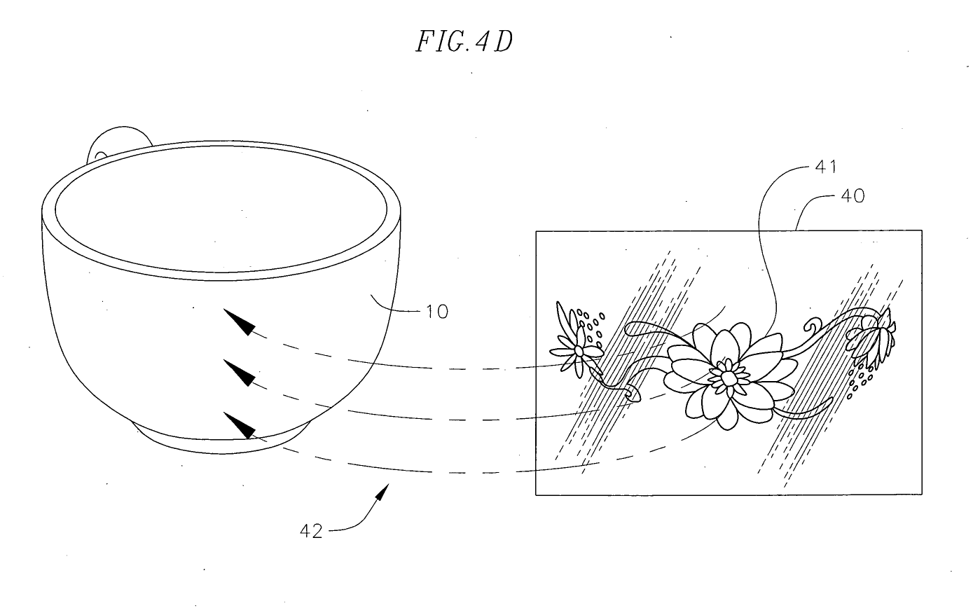

In another embodiment, the decorative indicia is applied to the molded clay object using a transfer process, as shown in FIGS. 4A, 4B, 4C and 4D. The transfer process may be used to apply the decorative indicia 20 to a curved molded clay object 10. A sheet of transfer paper 40, as shown in FIG. 4A, is placed under a screen 48, as shown in FIG. 4B. In the transfer process, ceramic paint is applied to the screen 48 with perforations 47 having an outline of the decorative indicia 20. An applicator 49 is used to press the ceramic paint through the perforations 47 in the screen 48 to deposit the ceramic paint onto the sheet of transfer paper 40 in an outline of the decorative indicia 41. The ceramic paint is transferred to the curved molded clay object 10 by smoothing the side of the sheet of transfer paper 40 with the ceramic paint onto the curved molded clay object 10, as shown by arrows 42 in FIG. 4D. The sheet of transfer paper 40 is removed after a few seconds have passed to allow the ceramic paint to be absorbed into the curved molded clay object 10.

For some decorative indicia, such as large decorative indicia or decorative indicia for multiple surfaces, the transfer process may be repeated with one or more screens. Ceramic paint is applied to the screen previously used or a new screen and an applicator is used to press the ceramic paint through the perforations in the screen onto another sheet of transfer paper. The ceramic paint is transferred to the curved molded clay object 10 by smoothing the side of the transfer paper with the ceramic paint onto the curved molded clay object 10 and the transfer paper is removed after a few seconds. This transfer process may be repeated until all of the desired decorative indicia have been applied to the curved molded clay object 10.

The curved molded clay object 10 is then fired and allowed to cool in a kiln to permanently fix the decorative indicia.

Once the curved molded clay object 10 is removed from the kiln, it may be decorated by a consumer. The consumer applies ceramic paint to the curved molded clay object 10 within regions 30 indicated by the decorative indicia 20, as shown in FIG. 3A. The colored and decorated curved molded clay object 10 is thereafter coated with a glaze. The curved molded clay object 10 is fired and cooled to room temperature in a kiln to fix the ceramic paint in a permanent state and create a wear-resistant coating. The outlines remain visible in the finished piece.

In another embodiment, the ceramic paint used to outline the decorative indicia is a single color.

In another embodiment, the ceramic paint used to outline the decorative indicia is a slow-drying formulation.

In another embodiment, the molded clay object 10, 11 is coated with an acrylic coating after the decorative indicia 20, 21 have been applied and it has been fired and removed from the kiln. Now the consumer may apply indelible ink, such as markings from permanent markers, to the molded clay object 10, 11 within regions 30, 31 indicated by the decorative indicia 20, 21. There is no need for adding a glaze or kiln firing after the indelible ink has been applied to a molded clay object 10, 11 that has an acrylic coating. The indelible ink is permanently fixed to the acrylic coating upon application.

The present invention has been described in preferred and exemplary embodiments and aspects, but is not limited thereto. Persons skilled in the art will appreciate that other modifications and applications can be made without meaningfully departing from the invention. Accordingly, the foregoing description should not be read as limited to the precise embodiments and aspects described, but should be read consistent with and as support for the following claims, which are to have their fullest and fairest scope.

What is claimed is:

1. A method for preparing a molded clay object for receiving finishing decorations, the method comprising:
applying ceramic paint to the molded clay object with an applicator to trace on the molded clay object a complete outline of decorative indicia;
firing the molded clay object in a kiln to fix the outline in a permanent state whereby the molded clay object is prepared to receive coloration and other decorative material applied by a user prior to being glazed and fired a second time to produce a finished object; and
cooling the molded clay object in the kiln to room temperature.

2. The method of claim 1, wherein regions within the outline identify areas for ceramic paint application and includes the step of applying ceramic paint to produce the desired finished coloration and decoration.

3. The method of claim 1, the method further comprising:
coating the molded clay object with an acrylic material suitable for decoration with indelible ink.

4. The method of claim 3, the method further comprising the step of applying indelible inks of selected colors to produce the finished object.

5. The method of claim 1, wherein the ceramic paint is a single color.

6. The method of claim 1, wherein the ceramic paint comprises a medium comprising crushed glass.

7. A method for preparing a molded clay object for receiving finishing decorations, the method comprising:
applying ceramic paint to a first screen with perforations having an outline of a first decorative indicia;
using an applicator to press the ceramic paint through the perforations onto the molded clay object;
firing the molded clay object in a kiln to fix the first decorative indicia in a permanent state; and
cooling the molded clay object in the kiln to room temperature.

8. The method of claim 7, wherein regions within the outline identify areas for ceramic paint application and includes the step of applying ceramic paint to produce the desired finished coloration and decoration.

9. The method of claim 7, the method further comprising:
coating the molded clay object with an acrylic material suitable for decoration with indelible ink.

10. The method of claim 9, the method further comprising the step of applying indelible inks of selected colors to produce the finished object.

11. The method of claim 7, wherein the ceramic paint is a single color.

12. The method of claim 7, wherein the ceramic paint comprises a medium comprising crushed glass.

13. A method for preparing a molded clay object for receiving finishing decorations, the method comprising:
applying ceramic paint to a first screen with perforations having an outline of a first decorative indicia;
using an applicator to press the ceramic paint through the perforations onto a first side of a first sheet of transfer paper;
applying the first side of the first sheet of transfer paper to the molded clay object to transfer the first decorative indicia to the molded clay object;
removing the first sheet of transfer paper from the molded clay object;
firing the molded clay object in a kiln to fix the first decorative indicia in a permanent state; and
cooling the molded clay object in the kiln to room temperature.

14. The method of claim 13, the method further comprising:
applying ceramic paint to a second screen with perforations having an outline of a second decorative indicia;
using an applicator to press the ceramic paint through the perforations onto a first side of a second sheet of transfer paper;
applying the first side of the second sheet of transfer paper to the molded clay object to transfer the second decorative indicia to the molded clay object;
removing the second sheet of transfer paper from the molded clay object;
wherein the second sheet of transfer paper is removed prior to firing the molded clay object.

15. The method of claim 13, wherein the ceramic paint is a slow-drying formulation.

16. The method of claim 13, wherein regions within the outline identify areas for ceramic paint application and includes the step of applying ceramic paint to produce the desired finished coloration and decoration.

17. The method of claim 13, the method further comprising:
coating the molded clay object with an acrylic material suitable for decoration with indelible ink.

18. The method of claim 17, the method further comprising the step of applying indelible inks of selected colors to produce the finished object.

19. The method of claim 14, wherein the ceramic paint is a single color.

20. The method of claim 13, wherein the ceramic paint comprises a medium comprising crushed glass.

21. A method for decorating a molded clay object, the method comprising:
applying ceramic paint to the molded clay object within regions indicated by decorative indicia, wherein the decorative indicia has been fixed in a permanent state to the molded clay object by a first firing in a kiln;
coating the molded clay object in a glaze;
firing the molded clay object in the kiln to fix the ceramic paint in a permanent state and create a wear-resistant coating; and
cooling the molded clay object in the kiln to room temperature.

22. A method for preparing and decorating a molded clay object, the method comprising:
applying ceramic paint to the molded clay object with an applicator to trace on the molded clay object a complete outline of decorative indicia;
firing the molded clay object in a kiln a first time to fix the outline in a permanent state;
cooling the molded clay object in the kiln to room temperature;
applying ceramic paint to the molded clay object within regions indicated by decorative indicia;
coating the molded clay object in a glaze;
firing the molded clay object in the kiln a second time to fix the ceramic paint in a permanent state and create a wear-resistant coating; and
cooling the molded clay object in the kiln to room temperature.

23. The method of claim 22, wherein the ceramic paint is a single color.

24. The method of claim 22, wherein the ceramic paint comprises a medium comprising crushed glass.

25. The method of claim 22, wherein the ceramic paint is a slow-drying formulation.

26. A method for preparing and decorating a molded clay object, the method comprising:
applying ceramic paint to the molded clay object with an applicator to trace on the molded clay object a complete outline of decorative indicia;
firing the molded clay object in a kiln a first time to fix the outline in a permanent state;
cooling the molded clay object in the kiln to room temperature;
coating the molded clay object with an acrylic material suitable for decoration with indelible ink;
applying indelible ink to the molded clay object within regions indicated by decorative indicia.

27. The method of claim 26, wherein the ceramic paint is a single color.

28. The method of claim 26, wherein the ceramic paint comprises a medium comprising crushed glass.

29. The method of claim 26, wherein the ceramic paint is a slow-drying formulation.

30. A molded clay object for receiving finishing decorations, wherein:
ceramic paint is applied to the molded clay object with an applicator to trace on the molded clay object a complete outline of decorative indicia;
the molded clay object is fired in a kiln to fix the outline in a permanent state whereby the molded clay object is prepared to receive coloration and other decorative material applied by a user prior to being glazed and fired a second time to produce a finished object; and
the molded clay object is cooled in the kiln to room temperature.

31. The molded clay object of claim 30, wherein regions within the outline identify areas for ceramic paint application and includes the step of applying ceramic paint to produce the desired finished coloration and decoration.

32. The molded clay object of claim 30, wherein the molded clay object is coated with an acrylic material suitable for decoration with indelible ink.

33. The molded clay object of claim 32, wherein indelible inks of selected colors are applied to the molded clay object to produce the finished object.

34. The molded clay object of claim 30, wherein the ceramic paint is a single color.

35. The molded clay object of claim 30, wherein the ceramic paint comprises a medium comprising crushed glass.

36. A molded clay object for receiving finishing decoration comprising:
a blank object having been subjected to a first firing in a kiln to create a bisque;
a pattern of indicia tracing a decorative pattern on the object, the pattern of indicia having been created by applying ceramic paint in the decorative pattern and thereafter being subjected to a second firing to permanently fix the pattern of indicia on the object;
wherein the object is ready to receive the finishing decoration to be applied by a user of the object.
